(19) United States
(12) Patent Application Publication
(10) Pub. No.: US 2024/0277021 A1
(43) Pub. Date: Aug. 22, 2024

(54) Pitting And Cutting Process Of Fruit, In Particular Peaches, And The Corresponding Cutting Blades And Multi-Lane Machine

(71) Applicant: CTI FOODTECH S.R.L., Salerno (IT)

(72) Inventors: Biagio Crescenzo, Salerno (IT); Alessandro CRESCENZO, Montecorvino Pugliano (IT)

(21) Appl. No.: 18/571,495

(22) PCT Filed: Jun. 23, 2022
(86) PCT No.: PCT/IB22/55833

§ 371 Date: Dec. 18, 2023

(30) Foreign Application Priority Data
Jun. 24, 2021 (IT) 102021000016646

(51) Int. Cl. A23N 4/22; A23N 3/04; A23N 4/04

(52) U.S. Cl. CPC A23N 4/22; A23N 3/04; A23N 4/04

(57) ABSTRACT

A pitting and cutting process for fruit, in particular peaches, involves the coplanar insertion, inside each fruit, of right and left upper and lower cutting blades, reciprocally horizontally separating the blades, inserting in the fruit an upper and lower pitting knife, rotating the pitting knives around the pit, vertically displacing downward both the upper cutting blades and the lower cutting blades to complete the cutting of the fruit, returning the right and left upper cutting blades and the lower cutting blades, still in reciprocal horizontal separation, and reciprocally horizontally approaching the right and left upper cutting blades and the right and left lower cutting blades for repeating the process. The related machine is also described.

### CROSS-REFERENCE TO RELATED APPLICATIONS

This patent application claims priority of Italian Patent Application No. 102021000016646 filed on Jun. 24, 2021, the entire disclosure of which is incorporated herein by reference.

### TECHNICAL FIELD OF THE INVENTION

This invention concerns a pitting and cutting process of fruit, in particular peaches. It also concerns a related multi-lane machine for pitting and cutting fruit, in particular peaches.

### STATE OF THE ART

The current pitting systems are torque pitters and knife pitters. In the first, the fruit, once oriented, is transferred in the special arms equipped with mechanical or pneumatic hands. Subsequently, it is divided in two, locking the pit and, with the pit locked, and the cutting blades that have already separated the fruit in two halves, it rotates the two hands, one in the opposite direction to the other. Thus, the pit is detached from its natural seat and the two halves of the fruit are free of the pit.

In the second system, the knife pitting system, the conventional operations, and the sequence in which they occur, are: the orientation of the fruit, the cutting of the fruit in two halves, the penetration of the cutting blades into the fruit; at the end of the stroke of the two upper and lower heads moving the cutting blades for penetrating the fruit, there is the step for rotating the two pitting knives in a single rotation direction, a step that enables the detachment of the pit from the pulp. Before this step, a step for pre-cutting the fruit, both in the lower and in the upper part, is carried out; this facilitates the introduction of the pitting knives during the pitting step.

The drawbacks of the torque system are known in the market and, in the current state of the art. Even with an average of 90-94% of well positioned fruit, there is a pitting percentage of approximately 97-98% and a percentage of broken pits that can vary, depending on the fruit and its quality, from 3% to 10%. In addition, the torque systems typically need fruit of a certain quality and texture: fruit that is too green splits, fruit that is too ripe is squashed, and generates fragments of pits that are difficult to remove from the fruit in successive operations.

The drawbacks in the knife system are a less aesthetically clean cut and, with certain qualities of fruit, a weight yield that is a couple of percentages lower than the torque system. With the systems that use the continuous orientation of fruit, you obtain 100% of pitting but the same problems remain as far as regards broken pits and their fragments.

The patent U.S. Pat. No. 3,835,765 A, in the name of G. Tomelleri, had attempted to avoid this drawback. This patent describes equipment for pitting and cutting fruit orderly oriented along a single line with its axis in the vertical position and the stalk pointing upwards. In this piece of equipment, a pitting section for separating the pit from the fruit's pulp, while the pit remains inside the fruit, precedes a cutting section wherein a vertical cut is made in the sides of each piece of fruit so that it is divided in two halves. Tomelleri does not provide for a pre-cutting section wherein a pre-cutting blade cuts the fruit above to ease the insertion of crescent-shaped pitting blades.

Tomelleri uses vertical holding blades that sit alongside the pitting blades to hold the fruit still, confined between a cup element for supporting the fruit and a cap for pressing the fruit from above. In the pitting section, the vertical blades do not penetrate the entire depth of the fruit's pulp, but help the fruit to resist the torsion caused by the pitting blades. In fact, the fruit's pressing cap is not enough to keep it still. In any case, the vertical blades having the function of holding the fruit, cut the pulp of the same so that its fibres no longer have the function of containment and collaboration that prevents the opening of the pit vertically when the latter is not whole.

U.S. Pat. No. 3,878,309 A, in the name of G. R. Anderson, describes a multi-lane machine for pitting fruit.

The aesthetically worse cut, compared to the torque system, is due to the fact that the cutting blades of the fruit are of the same thickness as the pitting knife, to avoid the latter's tearing the pulp itself when it enters the fruit's pulp. The pulp is cut in a station before the pitting, using a pre-cutting blade.

The European patent 3419441 of the same applicant, in order to eliminate the drawback of broken pits and its fragments, involves three steps: pre-cutting, pitting, and cutting at three different stations, also inverting the cutting and pitting operations.

The European patent mentioned above provides lessons to resolve the problems relating to pitting in the presence of empty or inconsistent pits. In any case, the cutting is not aesthetically acceptable.

### Subject and Summary of the Invention

The purpose of this invention is to provide a process for pitting and cutting fruit, in particular peaches, that reduces the drawbacks of the prior art.

In particular, the purpose of this invention is to pit and subsequently cut the fruit in two halves without causing unacceptable deformation of the fruit.

In particular, one purpose of the invention is that of providing a process and a machine for precisely pitting and cutting.

Another purpose of the invention is that of enabling the precise insertion of pitting knives following a cut that precedes this insertion at a single station.

Another purpose of the invention is that of cutting the fruit in two halves in the same station.

An additional purpose of the invention is that of ensuring a reliable momentary locking of the fruit during the pitting operation.

Therefore, in one of its first aspects, this invention, according to claim 1, provides a pitting and cutting process for fruit, in particular peaches, advancing along several fruit lanes, the pieces of fruit being positioned with their axis in a vertical position in a fruit-holding flight, having recesses provided with a central opening and diametrical slots, in a pitting and cutting station comprising an upper head that is equipped with a momentary fruit locking device, upper pitting knives and upper cutting blades, and having an upper rest position, and a lower head equipped with lower pitting knives and lower cutting blades and having a lower rest position, wherein the a processing cycle comprises the following steps for each piece of fruit to be pitted and cut:
coplanar insertion, along said axis inside each piece of fruit, of right and left upper cutting blades which anticipate the movement of the upper head from its upper rest position and pass through a momentary locking of the fruit, and coplanar insertion of two right and left lower cutting blades which anticipate the movement of the lower head from its lower rest position and cross the fruit-holding flight, up to delimiting the pit of the fruit both above and below;
reciprocally horizontally separating the right and left upper cutting blades and the right and left lower cutting blades with respect to the pit in order to maintain a gap between the blades;
inserting in the fruit an upper pitting knife through said gap between the upper cutting blades and said momentary fruit locking device, and a lower pitting knife through said gap between the lower cutting blades and said central recess opening;
rotating the upper pitting knife and the lower pitting knife around the pit for at least 180° to perform pitting of the fruit;
returning the upper head to its upper rest position and the lower head to its lower rest position with the upper right and left cutting blades and the right and left lower cutting blades still in reciprocal horizontal separation; and
reciprocally horizontally approaching the right and left upper cutting blades and the right and left lower cutting blades starting a new processing cycle.

Another purpose of this invention is to provide a cutting blade for a machine for pitting and cutting fruit that reduces the drawbacks of the prior art.

In accordance with this invention, a cutting blade is provided for cutting fruit, in particular peaches, for a machine for pitting and cutting fruit, the cutting blade comprising a first and a second cutting edge configured to cut the fruit when the cutting blade is advanced vertically and a third cutting edge configured to cut the fruit when the cutting blade is advanced horizontally.

In this way, with a relatively small blade, it is possible to cut the fruit and implement the process described above.

In particular, the third cutting edge is basically perpendicular to the first cutting edge.

In this way, when the blade is inserted vertically in the fruit, the third cutting edge does not cut the fruit while, when the cutting blade is advanced horizontally, the first cutting edge does not cut the fruit.

In particular, the second cutting edge is arched and configured so that four cutting blades arranged around the fruit's pit, the one brought near to the other, form a closed ring around the pit.

In this way, a cut is formed around the fruit's pit that facilitates the insertion of the pitting knives.

In one embodiment, the second cutting edge describes a curve incident with a straight line described by the first cutting edge.

Wherein the first cutting edge is an edge on the end of the blade.

The second cutting edge is an edge on the lower surface of the blade.

The second cutting edge is an edge on the outer upper surface of the blade.

In a second aspect, the invention provides a multi-lane machine as defined in claim 8 and in the claims dependent on it, comprising:
a longitudinal frame,
a conveyor having fruit-holding flights advancing along the longitudinal frame, and shaped with a series of recesses that are sized according to the fruit to be transported and are transversely spaced, each recess being provided below with a central opening and diametrical slots,
a pitting and cutting station having:
   an upper head and a lower head, arranged transversely on the longitudinal frame and vertically movable with respect to the fruit-holding flights,
   a plurality of momentary fruit locking devices mounted slidingly on the upper head;
   a plurality of upper and lower pitting knives rotatably mounted on the upper head and on the lower head, and
   a plurality of upper cutting blades and a plurality of lower cutting blades mounted opposite respectively on the upper head and the lower head,
wherein said plurality of upper cutting blades and said plurality of lower cutting blades form pairs of blades capable of moving vertically and simultaneously with respect to the upper head and, respectively, with respect to the lower head, each pair of blades comprising a right blade and a left blade which are adapted to move horizontally with respect to each other.

In summary, the invention is based on the combination of the three operations: pre-cutting, pitting, and cutting, mentioned above, in a single station. The blades, initially, penetrate the fruit until reaching the pit, being coupled and brought towards the central axis of the fruit both at the upper part and at the lower part; in fact, they prepare the pulp for the passage of the pitting knife, while the fruit is held by a momentary locking device. Thus, the upper and lower blades move laterally to enable the passage of the upper and lower pitting knives so that they reach the pit. The blades, that preferably have a cutting edge on the end, on the lower surface, and on the outer upper surface, when they move outside, sever the fibres from the inside outside.

The blades collaborate with the locking device of the fruit during the pitting operation and move downwards while the upper and lower pitting knives end their rotation and move away from the fruit.

It should be understood that, according to this invention, the pitting knives move integrally with the corresponding heads, while the upper and lower cutting blades have vertical and horizontal movements in relation to the heads, thanks to their arrangement on an upper frame and on a lower flattened structure, both vertically movable and supporting blade-holding slides that are horizontally movable. It is precisely this arrangement that enables the combination of the above-mentioned three steps in a single station with the sequence described above. Thanks to the contemporaneous cutting, the risk of cutting the fruit twice is avoided, because both the pre-cutting and the cutting are performed by the same blades, without any change of position in the fruit-holding flight.

The final product, then, has a smooth and clean cut as occurs with a torque machine.

### BRIEF DESCRIPTION OF THE DRAWINGS

Additional features and advantages of this invention will be clearer from the indicative, and therefore non-limiting, description of one embodiment of a multi-lane machine for pitting and cutting peaches, as illustrated in the attached drawings wherein:

FIG. 1 is a partial schematic, perspective view of a multi-lane machine according to this invention;

FIG. 2 is a schematic front view on an enlarged scale of the pitting and cutting station of the machine in FIG. 1, comprising an upper head with eight pitting and cutting assemblies, and a lower head shown only in part;

FIG. 3 is an exploded perspective view of the pitting and cutting station in FIG. 2;

FIG. 4 is an exploded perspective view of the upper head of the pitting and cutting station in FIG. 2;

FIG. 5 is an exploded perspective view of the lower head of the pitting and cutting station in FIG. 2;

FIG. 6 is a plan view from below of the sole lower head in FIG. 2;

FIG. 7 is a schematic side view, in partial cross-section, of a pitting and cutting assembly in FIG. 2, in a first operating position;

FIG. 8 is a schematic side view, in partial cross-section, of a pitting and cutting assembly in FIG. 2, in a second operating position;

FIG. 9 is a schematic side view, in partial cross-section, of a pitting and cutting assembly in FIG. 2, in a third operating position;

FIG. 10 is a schematic side view, in partial cross-section, of a pitting and cutting assembly in FIG. 2, in a fourth operating position;

FIG. 11 is a schematic side view, in partial cross-section, of a pitting and cutting assembly in FIG. 2, in a fifth operating position;

FIG. 12 is a schematic side view, in partial cross-section, of a pitting and cutting assembly in FIG. 2, in a sixth operating position.

### DETAILED DESCRIPTION OF PREFERRED EMBODIMENTS OF THE INVENTION

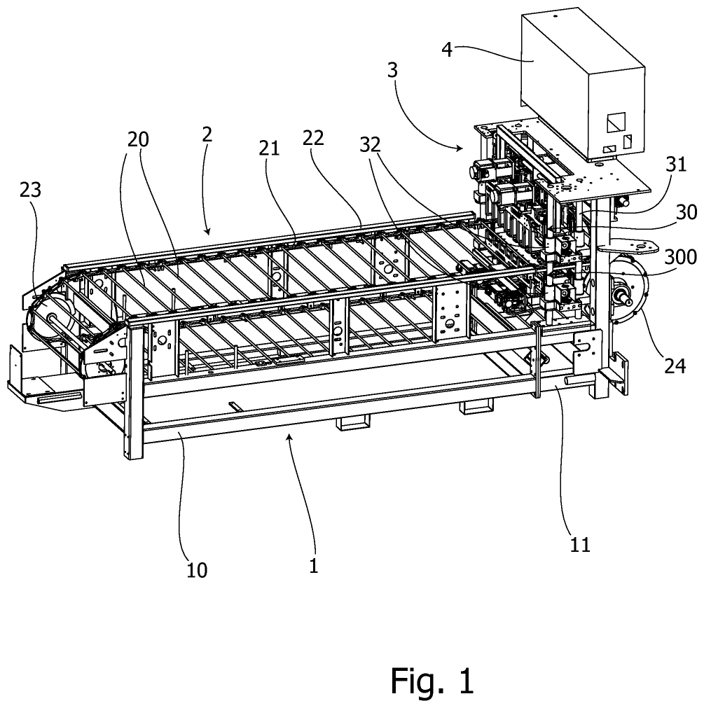

Reference is initially made to FIG. 1, which is a partial schematic perspective view of a multi-lane machine for cutting fruit, in particular peaches, according to this invention. The multi-lane machine comprises a longitudinal frame 1, a conveyor 2 with fruit-holding flights, a pitting and cutting station 3, and a cabinet 4 for the electrical system.

The longitudinal frame 1 is composed of a front part 10 and a back part 11.

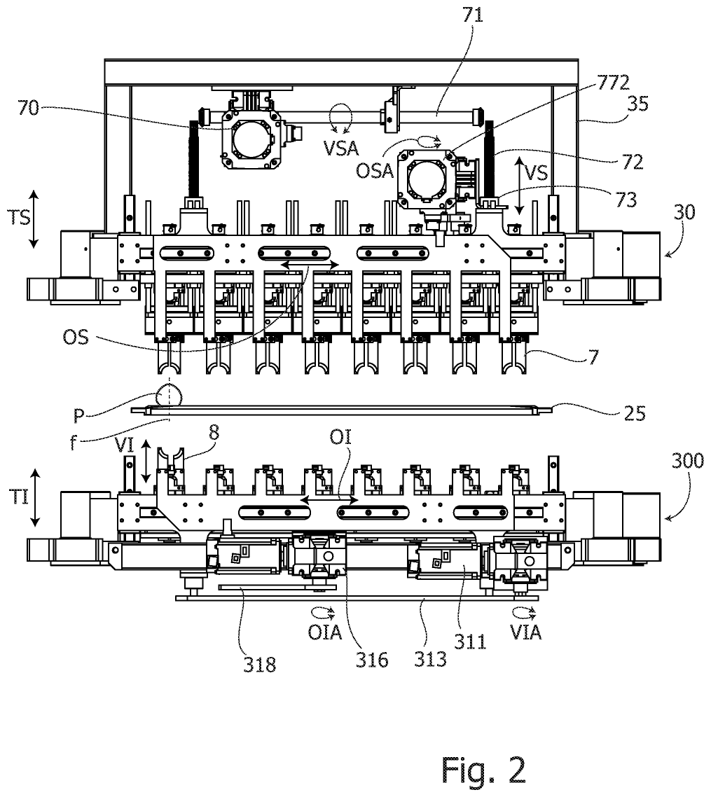

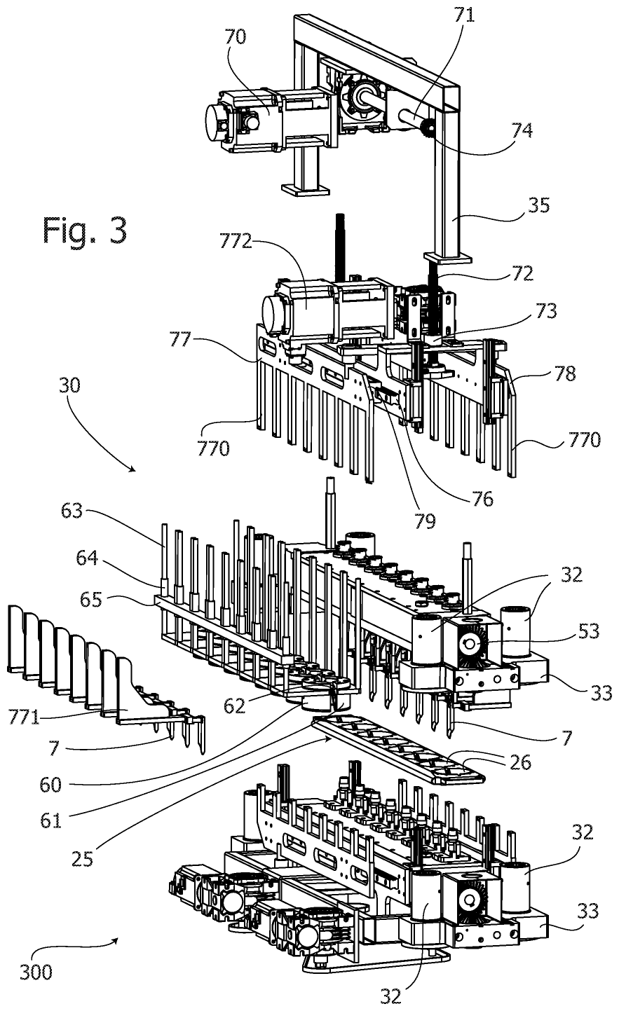

The conveyor 2 consists, according to the conventional art, of multiple cross rods 20. The cross rods 20 are longitudinally regularly spaced apart by a pitch chosen depending on the movement of an oscillator, which is known and not shown here. The fruits are fed onto the conveyor 2 from a feeding station, not shown, on the left side of FIG. 1, and advanced towards the right into the pitting and cutting station 3. The cross rods 20 are connected together at the opposite ends in succession via mesh elements, generically indicated with the number 21 and supported by rollers 22, of a known type. The rollers 22 engage with pairs of wheels 23, 24 respectively in the front and back ends of the conveyor 2, on which the belt, formed from fruit-holding flights 25 or flights connected in succession via mesh elements 21, runs. A fruit-holding flight 25 is shown in FIG. 2, which is a schematic front view on an enlarged scale of the pitting and cutting station of the machine in FIG. 1, comprising an upper head with eight pitting and cutting assemblies, and a lower head shown only in part. As shown in FIG. 3, which is an exploded perspective view of the pitting and cutting station 3 in FIG. 2, the fruit-holding flight 25 is conventionally shaped with a series of recesses 26 sized based on the fruit P to be conveyed and transversely spaced apart. Each recess 26 is provided with a central opening and diametrical slots.

The pitting and cutting station 3 comprise an upper head 30 and a lower head 300, arranged transversely on the longitudinal frame 1 and vertically moveable the one above the other below the fruit-holding flights 25, on vertical guides, generically indicated with the number 31 (FIG. 1), perpendicular to the longitudinal frame 1. The movement means of the heads 30, 300 are neither shown nor described since they are known.

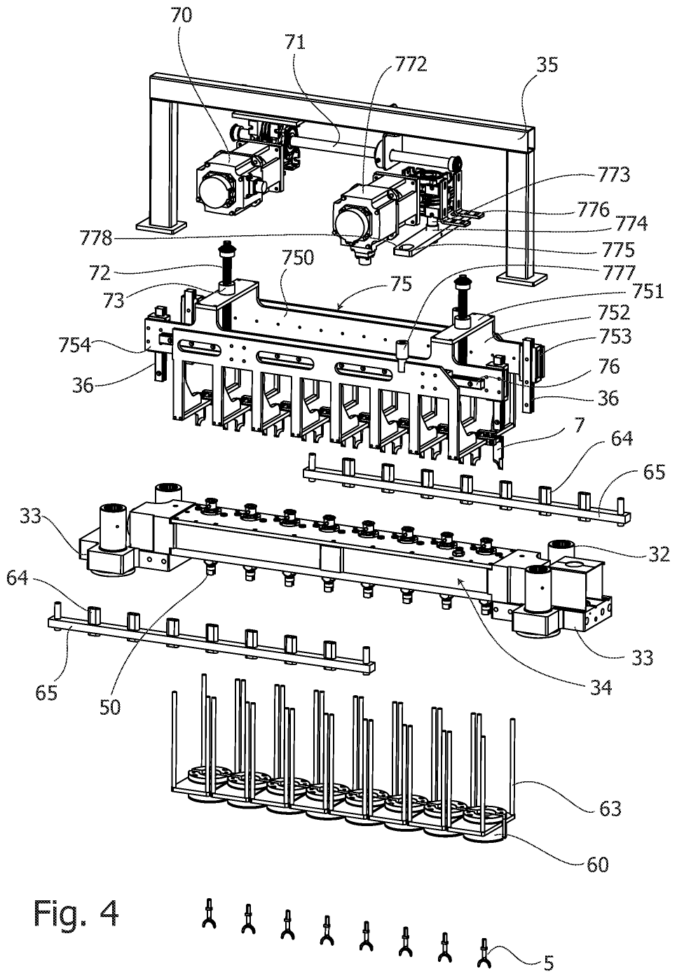

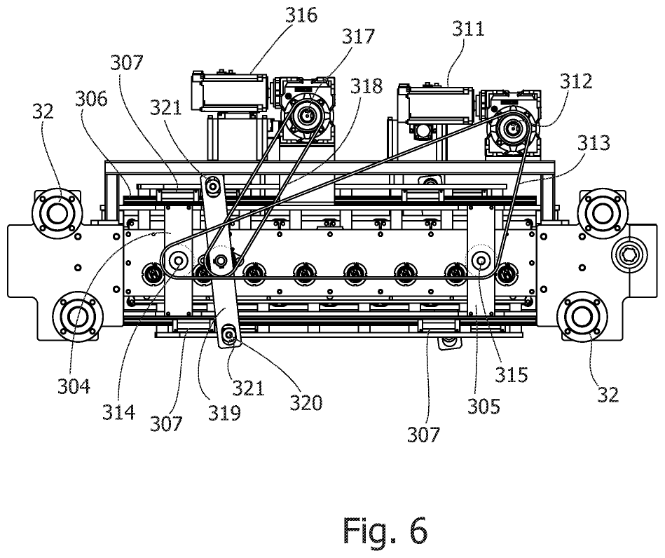

To better understand the pitting and cutting station 3, please also refer to FIGS. 4 to 6 that are an exploded perspective view of the sole upper head 30, an exploded perspective view and, respectively, a plan view from below of the sole lower head 300. The figures use the same reference numbers to indicate the same or similar parts of the upper head 30 and the lower head 300.

For the sliding of the upper head 30 and lower head 300 on the vertical guides 31, both the heads have sliding sleeves generically indicated with the number 32, as shown in more detail in FIGS. 3 to 6. The sleeves 32, preferably four of them per head, are integral to drilled bases, generically indicated with the number 33. The drilled bases 33 (FIG. 4) support a prismatic container 34 inside of which pitting knife 5 drive devices are arranged in a known way, individually supported by knife support heads 50. The pitting knives 5 comprise a rod 51 and a crescent-shaped blade 52. The shape and size of the knives are different according to the calibre of the fruit to cut. As shown, in particular, in FIG. 3, the pitting knives 5 are rotated contemporaneously for an arc of at least 180° via mechanisms not shown, kinematically together with a conical pair 53.

With reference, in particular, to FIGS. 3 and 4, it should be noted that multiple momentary locking devices 6 are mounted on the upper head 30 in a number equal to the fruit-holding flight conveyor 2 lines. The momentary locking devices 6, as is known, serve to lock each piece of fruit P oriented in the recess 26 of its fruit-holding flight 25. Each of these comprise an elastically deformable member, which, according to this invention, consists of two half-cups 60, 61 placed alongside each other and reciprocally distanced by a slot 62, whose function will be clarified below. The two half-cups 60, 61 of each elastically deformable member are connected to a compressed air system not shown to inflate when they need to hold the fruit P and to deflate when they need to release it. Each half-cup 60, 61 is mounted slidably on the upper head 30 via a pair of rods 63 to rest on the respective piece of fruit P. Each rod 63 can slide in a guide 64. The guides 64 are fixed to the upper head 30 via a transverse bar 65.

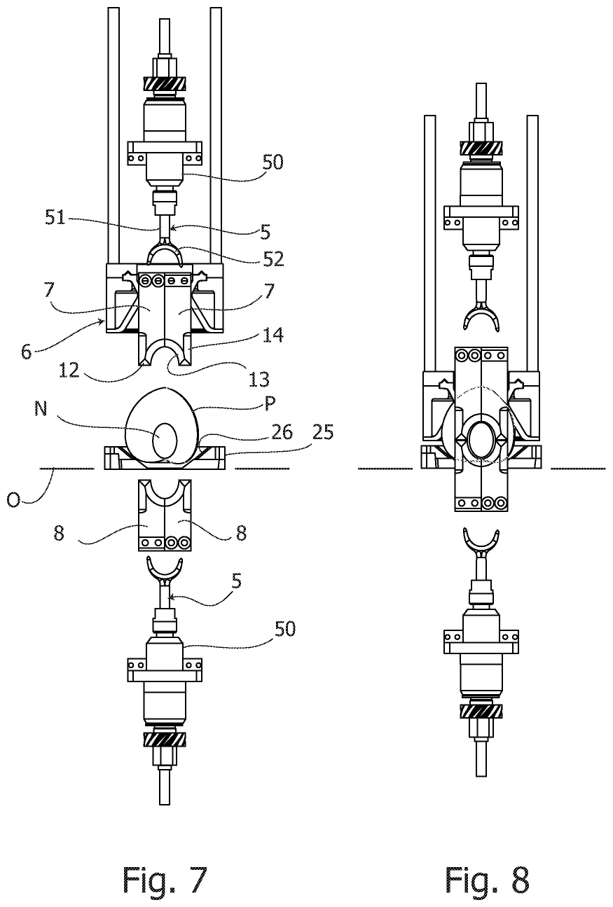

Upper blades, generically indicated with the number 7, and lower blades, generically indicated with the number 8, for cutting the fruit P are mounted vertically movable in relation to the upper head 30 and to the lower head 300, according to this invention. To cut each piece of fruit P, an upper right blade and an upper left blade are used, as well as a lower right blade and a lower left blade. The right and left blades are symmetrically identical, as will be seen below in FIGS. 7 to 12, which are schematic side views, partially in cross-section, of a pitting and cutting assembly in FIG. 2, in six successive operating positions.

In addition, the upper right and left cutting blades of each piece of fruit P are horizontally moveable, the one in relation to the other, like the lower right and left cutting blades.

Below, an embodiment that enables the upper and lower blades to move in relation to their heads in a vertical direction, and each right blade to move horizontally in relation to its left blade to cut the piece of fruit P, is described.

A portal 35 to support the motorisation is fixed to the upper head 30 to support upper vertical drive means for vertically moving the upper blades 7. The upper actuation means comprise a first brushless gearmotor 70, a first drive shaft 71, and a pair of screws 72 and nuts 73. Every screw 72, preferably a screw with a trapezoid profile, is mounted on the upper head 30 and connected to the first drive shaft 71 via a conical pair 74. Every nut 73 is mounted on an upper blade holder frame, indicated overall with the number 75 (FIG. 4).

The upper blade holder frame 75 has a pair of upper parallel side walls 750. These walls, which are opposite each other and parallel to the upper head 30, are connected by at least two crosspieces 751 where the nut 73 is mounted. On the opposite side 752 of the upper parallel side walls 750, there is a sliding vertical coupling of the frame 75 with the upper head 30. This sliding vertical coupling is preferably produced with multiple prismatic guides 36 vertically fixed to the upper head 30 and with corresponding upper sliding means, for example recirculating ball bearings 753. Thanks to the gearmotor 70, the frame 75 can be moved, controlled by a PLC, in relation to the upper head 30.

On the outer side 754 of the walls 750 of the frame 75, there is a prismatic guide 76 for transversal sliding coupling.

As better shown in FIG. 3, an upper left blade holder slide 77 and an upper right blade holder slide 78 are provided with upper transversal sliding means, in the form of a recirculating ball bearing 79, cooperating with the prismatic guide 76 for transversal sliding coupling.

The upper slides 77 and 78 are basically comb-like plates with vertical prongs generically indicated with the number 770. Each prong 770 supports a left or right blade 7 via a support element generically indicated with 771. The support element 771 of the upper slide 77 has, at its end, a left blade 7 that must be coplanar with the right blade 7 of the upper slide 78. The upper slides 77 and 78 are controlled in their horizontal movement via upper horizontal actuation means that comprise a second brushless gearmotor 772 equipped with a second drive shaft 773, and a lever 774 mounted on the second drive shaft 773. The lever 774 has a left end 775 and a right end 776, respectively connected with first cylindrical joints 777 to the upper left blade holder slide 77 and to the upper right blade holder slide 78. The cylindrical joint 777 can be produced with a brass bearing engaged in a hole 778 of the lever 774.

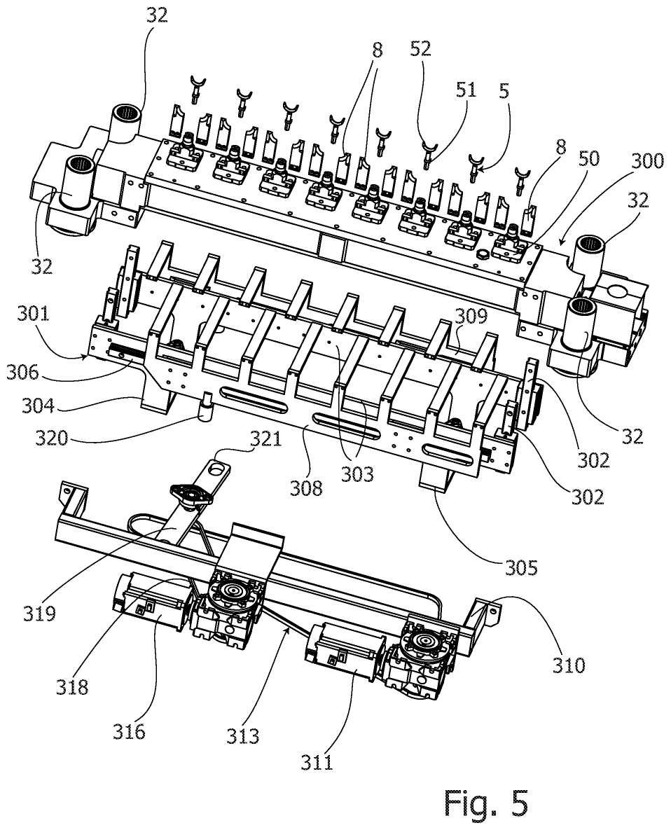

Referring to FIG. 5, the lower head 300 is shown, whose pitting part is basically identical to that of the upper head 30. The difference is in the arrangement of the knives 5 upwards. The arrangement of the cutting blades is basically the same as that of the upper head 30, but more compact, due to the smaller amount of space available between the fruit-holding flights of the conveyor belt forward movement and return movement.

The cutting arrangement on the lower head 300 comprises a support 310 for the motorisation for moving the blades both in the vertical and horizontal direction. For issues of space, the support 310 is in the shape of a C-shaped bracket fixed at the front of the lower head 300.

A lower blade holder flattened structure 301 is mounted so it can slide vertically on the lower head 300. For this purpose, multiple prismatic guides 302 for vertical sliding coupling are mounted on the lower head 300. The lower blade holder flattened structure 301 surrounds the lower head having opposite parallel side walls 303 and U-shaped crosspieces turned downwards identified with the numbers 304 and 305. The opposite parallel side walls 303 have, on the inner side, lower vertical sliding means cooperating with the prismatic guides for vertical sliding coupling 302. These lower vertical sliding means are preferably recirculating ball bearings.

The opposite parallel side walls 303 of the flattened structure 301 have, on their outer sides, prismatic guides for horizontal sliding coupling 306 designed to cooperate with lower horizontal sliding means 307, which are preferably recirculating ball bearings. The lower horizontal sliding means 307 are mounted on a lower left blade holder slide 308 and on a lower right blade holder slide 309.

On the bracket 310, fixed in front of the lower head 300, are mounted lower vertical drive means for vertically moving the blades via the movement of the lower blade holder flattened structure 301, and lower horizontal drive means designed to contemporaneously move, horizontally, the lower left blade holder slide 308 and the lower right blade holder slide 309.

Lower left blades 8 are mounted on the lower left blade holder slide 308 and lower right blades 8 are mounted on the lower right blade holder slide 309. The lower left and right blades 8 form multiple pairs of lower blades designed to contemporaneously cut multiple pieces of fruit P on each fruit-holding flight 25. This happens thanks to lower horizontal drive means designed to contemporaneously move the lower left blade holder slide 308 and the lower right blade holder slide 309 in opposite directions.

The lower vertical drive means comprise a third brushless gearmotor 311 having a drive shaft 312 and a first chain transmission 313 that runs on a gear mounted on the drive shaft 312 and on two gears of screw-nut devices 314 and 315. These devices have the screw mounted on the lower head 300 and the nut on the U-shaped crosspieces 304 and 305 of the lower blade holder flattened structure 301.

The lower horizontal drive means comprise a brushless gearmotor 316 having a drive shaft 317 and a second chain transmission 318 running on a gear mounted on the drive shaft 317 and on a gear that is integral with a lever 319. The lever 319 has end joints with the left and right blade-holder slides. These joints may be cylindrical joints made with a pair of brass bearings 320 engaged in elliptic holes 321 in the ends of the lever 319.

As far as regards the operation of the machine according to this invention, the conveyor belt 2 moves and stops when the fruit P arrives in the single processing position. The upper 30 and lower 300 heads are located, at this time, in their maximum opening, or rest position, represented in FIG. 2. This rest position is only depicted in FIG. 7 in terms of a single pitting and cutting assembly, i.e., in relation just to one piece of fruit P. The subsequent positions of the upper heads 30 and the lower heads 300 in the processing cycle are depicted, for reasons of clarity, only in FIGS. 8 to 12, which are lateral, schematic views, partially in cross-section, of a pitting and cutting assembly in FIG. 2, in successive operations of the processing cycle. The position of the heads in FIG. 2, with the piece of fruit P with its pit N and its axis f positioned in the recess 26 of the fruit-holding flight 25, is reproduced in FIG. 7. Above the fruit-holding flight 25, you can see the upper left and right blades 7, the momentary locking device 6, and the pitting knife 5 carried by the support head 50. Below the fruit-holding flight 25, you can see the lower left and right blades 8 and the pitting knife 5 carried by the support head 50. As far as regards the upper 7 and lower 8 cutting blades, it should be noted that each blade has an end cutting edge 12, an arched cutting edge on the lower surface 13, and a straight cutting edge on the upper surface 14. For clarity, the above-indicated reference numbers are not indicated in FIGS. 8 to 11. In FIG. 12, the fruit is depicted as in FIG. 7, but it should be understood that it is pitted and cut.

Returning to the rest position in FIGS. 2 and 7, once a fruit-holding flight 25 on the conveyor belt 2 has stopped under the pitting and cutting assemblies, the upper 30 and lower 300 heads start to close on the fruit. The upper head 30 is lowered (FIG. 8), due to the oscillator and related components, according to the arrow VS (FIG. 2). On the upper head 30 cutting blades 7 are mounted with a length greater than those on the lower head 300 since the pit N in peaches is off-centre, towards the bottom. The upper blades 7 and the lower blades 8 are already positioned at the start in front of the pitting knives 5 so that they enter into contact with the fruit before the latter, thus opening the road in the fruit P and avoiding grooves. As described above, the cutting blades are mounted on vertical and horizontal guide systems, firmly attached to the respective head; for each guide system, there is a brushless motor able to ensure the movement of the blades with excellent performance and reliability over time. The above-mentioned system enables the blades to move together with the head, according to the arrow TS, but also in relation to the upper head 30 according to the arrow VS, so that the blades also have a relative motion in relation to the head and independently of its movement. This double-guide system is present on both the heads, and this enables the blades to have full freedom of movement in relation to the heads on which they are mounted. The vertical movement of the lower head 300 occurs according to the arrow TI, while the relative movement of the lower blades 8 occurs according to the arrow VI. The relative vertical movement of the upper blades 7 in relation to the upper head 30 occurs with the rotation of the first drive shaft 71 due to the first gearmotor 70 according to the curved arrow VSA. The relative vertical movement of the lower blades 8 in relation to the lower head 300 occurs with the rotation of the third gearmotor 311 according to the curved arrow VIA.

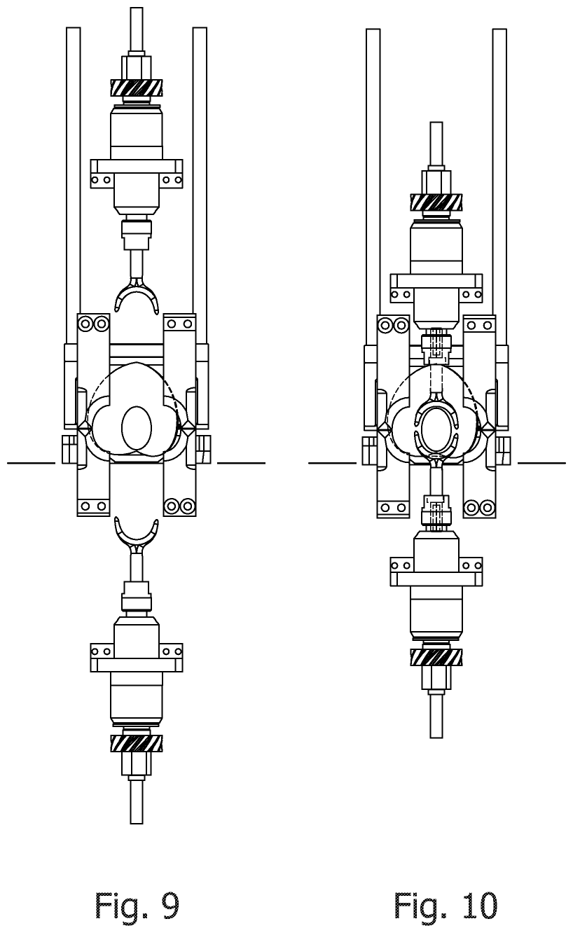

Thanks to the freedom that they have, the cutting blades 7, 8 precede the knives 5 according to the arrows VS and VI until closing near the midpoint of the pit (FIG. 8), with the heads that are still at full speed. Having reached the midpoint of the pit, the upper blades 7 start to open horizontally to end up in the position shown in FIG. 9 thanks to the horizontal movement according to the arrow OS via the second gearmotor 772 and its action according to the curved arrow OSA. At the same time, the lower blades 8 start to open horizontally and reach the position shown in FIG. 9 according to the arrows OI, thanks to the action of the third gearmotor 311 according to the curved arrow OIA thanks to the chain transmission 318. The upper blades 7 and the lower blades 8 move further away from each other enough to enable the knife 5 to move past them and reach near the pit N to correctly remove the peach's pit. Obviously, since the blades precede the knives when the heads are closing, once having reached the midpoint, the blades start to move in the opposite vertical direction too, via the actions described above in relation to the movement of the heads and with equal absolute speed, so as to appear, to the human eye, still on the horizontal line and moving only horizontally (FIG. 10). Together with the blades and with the same advance in relation to the knife, the momentary locking device 6 descends, i.e., the pneumatic half-cups 60, 61, as shown in FIG. 8. The half-cups 60, 61 that are equipped with a hot vulcanised rubber membrane on an aluminium frame, rest on the fruit P and are locked in this position thanks to a brake, of a known type, independently for each half-cup, so as to enable the processing of fruits with different diameters; the half-cups expand on the fruit, vigorously embracing it, but without affecting the shape of the fruit itself. Thus, the fruit is clamped well in position and will not be able to move until the completion of all processing steps.

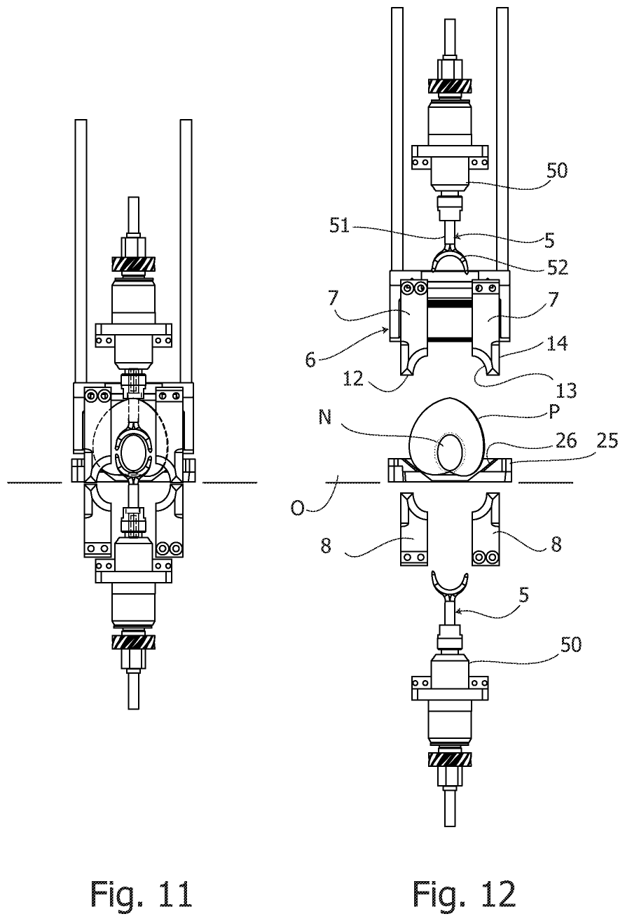

FIG. 11 shows the vertical movement of the upper blades 7 and of the lower blades 8 downwards. It should be understood that this movement entails the complete cutting of the fruit P. The blades 7, without the cooperation of the lower blades 8, are well planted in the fruit P and cooperate, together with the pneumatic cup, in holding it still during pitting. At this point, the knives in the pitting position perform, optionally, a 180° or 360° rotation, so as to create an oval containing the pit. At this point, two half peaches correctly cut are obtained and an oval containing the pit that will then be discarded.

Alternatively, the vertical movement of the upper blades 7 and of the lower blades 8 downwards, to completely, vertically cut the fruit, can be carried out after the 180° or 360° rotation of the pitting knife to create the oval. The choice of completely cutting the fruit before or after the pitting may depend on the nature and texture of the fruit to be processed.

After pitting the fruit, the pneumatic cups relax, thanks to the reduction in pressure of the air present inside, and the fruit is freed from its grip. The heads open (FIG. 12) and the blades are separated from each other. The processing cycle repeats after the blades 7 and 8 are repositioned, closed, in front of the knives 5, as shown in FIG. 7.

1. A pitting and cutting process of fruit, in particular peaches, advancing along several fruit lanes, fruits being positioned with their axis (f) in a vertical position in a fruit-holding flight having recesses, provided with a central opening and diametrical slots, in a pitting and cutting station, the process comprising:
an upper head that is equipped with a momentary fruit locking device, upper pitting knives and upper cutting blades, and has an upper rest position, and
a lower head that is equipped with lower pitting knives and lower cutting blades, and has a lower rest position,
the process being characterized by the following steps:
coplanar inserting along said axis inside each fruit right and left upper cutting blades which anticipate the movement of the upper head from its upper rest position and pass through a momentary locking of the fruit, and right and left lower cutting blades which anticipate the movement of the lower head from its lower rest position and cross the fruit-holding flight, up to delimit the pit (N) of the fruit both above and below;
reciprocally horizontally separating the right and left upper cutting blades and the right and left lower cutting blades with respect to the pit in order to maintain a gap between each right blade and left blade;
inserting in the fruit an upper pitting knife through said gap through both the upper cutting blades and said momentary fruit locking device, and a lower pitting knife through said gap between the lower cutting blades and said central recess opening;
rotating the upper pitting knife and the lower pitting knife around the pit (N) for at least 180° to perform pitting of the fruit;
returning the upper head to its upper rest position and the lower head (300) to its lower rest position with both the upper right and left cutting blades and the right and left lower cutting blades still in reciprocal horizontal separation; and
reciprocally horizontally approaching both the right and left upper cutting blades and the right and left lower cutting blades for repeating the process.

2. The process according to claim 1, wherein, before the step of rotating the upper pitting knife and the lower pitting knife around the pit, a step of vertically downward displacing both the upper cutting blades and the lower cutting blades is carried out to complete a vertical cutting of the fruit.

3. The process according to claim 1, wherein, after the step of rotating the upper pitting knife and the lower pitting knife around the pit, a step of vertically downward displacing both the upper cutting blades and the lower cutting blades is carried out to complete a vertical cutting of the fruit.

4. A cutting blade for cutting fruit, in particular peaches, for a machine for pitting and cutting fruit, the cutting blade comprising a first and a second cutting edge configured to cut the fruit when the cutting blade is advanced vertically and a third cutting edge configured to cut the fruit when the cutting blade is advanced horizontally.

5. The cutting blade as claimed in claim 4, wherein the third cutting edge is basically perpendicular to the first cutting edge.

6. The cutting blade as claimed in claim 4 or 5, wherein the third cutting edge is arched and configured so that when four cutting blades arranged around the pit of the fruit, the one brought near to the other, form a closed ring around the pit.

7. A multi-lane machine for pitting and cutting fruit, in particular peaches, the machine comprising:
a longitudinal frame,
a conveyor having fruit-holding flights advancing along the longitudinal frame, and shaped with a series of recesses that are sized according to the fruit to be transported and are transversely spaced, each recess being provided below with a central opening and diametrical slots,
a pitting and cutting station having:
an upper head and a lower head, arranged transversely on the longitudinal frame and movable vertically with respect to the fruit-holding flights,
a plurality of devices for the momentary fruit locking mounted slidingly on the upper head;
a plurality of upper and lower pitting knives rotatably mounted on the upper head and on the lower head, and
a plurality of upper cutting blades and a plurality of lower cutting blades mounted facing respectively on the upper head and the lower head,
characterized in that said plurality of upper cutting blades form pairs of blades capable of moving vertically and simultaneously with respect to the upper head, and said plurality of lower cutting blades form pairs of blades capable of moving vertically and simultaneously with respect to the lower head, each pair of blades comprising a right blade and a left blade which are adapted to move horizontally with respect to each other.

8. The multi-lane machine according to claim 7, wherein the upper head comprises:
a portal fixed on the upper head;
upper vertical drive means for the vertical movement of the blades supported by said portal;
an upper blade holder frame (75), mounted vertically sliding on the upper head (30), the upper blade holder frame being connected to said upper actuation means and having opposite upper parallel side walls (750) connected by at least two crosspieces;
a plurality of prismatic guides for vertical sliding coupling mounted on the upper head;
upper vertical sliding means on the inside of each of the opposite upper parallel side walls cooperating with the prismatic guides for vertical sliding coupling;
a prismatic guide for transversal sliding coupling mounted on the outside of each of the opposite upper parallel side walls;
an upper left blade holder slide and an upper right blade holder slide, both provided with upper transversal sliding means cooperating with the prismatic guides for transversal sliding coupling;
upper left blades mounted on the upper left blade holder slide and upper right blades mounted on the upper right blade holder slide, the upper left blades and the upper right blades forming a plurality of pairs of upper blades able to simultaneously cut a plurality of fruits on each fruit holding flight; and
upper horizontal drive means mounted on the upper blade holder frame and able to simultaneously move the upper left blade holder slide and an upper right blade holder slide in a horizontal direction.

9. The multi-lane machine according to claim 7, wherein the lower head comprises:
a bracket fixed to the front of the lower head;
lower vertical drive means supported by said bracket for the vertical movement of the blades;
a lower blade holder flattened structure mounted vertically slidable on the lower head, the lower blade holder flattened structure being connected to said lower vertical drive means and having opposite lower parallel side walls with cross members;
a plurality of prismatic guides for vertical sliding coupling mounted on the lower head;
lower vertical sliding means on the inside of each of the opposite lower parallel side walls cooperating with the prismatic guides for vertical sliding coupling.
a prismatic guide for transverse sliding coupling mounted on the outside of each of the opposite lower parallel side walls;
a lower left blade holder slide and a lower right blade holder slide, both equipped with sliding means cooperating with the prismatic guides for transversal sliding coupling;
lower left blades mounted on the lower left blade holder slide and lower right blades mounted on the lower right blade holder slide, the lower left blades and the lower right blades forming a plurality of pairs of lower blades suitable for simultaneously cutting a plurality of fruits (P) on each fruit holding flight;
lower horizontal drive means that are supported by said bracket and adapted to simultaneously move the lower left blade holder slide and the lower right blade holder slide.

10. The machine according to claim 8, wherein said upper vertical drive means comprises:
a first brushless gearmotor,
a first drive shaft, and
a pair of screw-nut assembly, the screws being mounted on the upper head and connected to the first drive shaft, the nuts being mounted on the crosspieces of the upper blade holder frame.

11. The machine according to claim 8, wherein said upper horizontal drive means comprises:
a second brushless gearmotor, equipped with a second drive shaft, and
a lever mounted on said drive shaft and having a left end and a right end, respectively connected with respective first cylindrical joints to the upper left blade holder slide and to the upper right blade holder slide.

12. The machine according to claim 9, wherein said lower vertical drive means comprises:
a third brushless gearmotor, equipped with a third drive shaft;
a first chain transmission, and
a pair of screw-nut assembly, the screws being mounted on the lower head and connected to the third drive shaft by means of the chain transmission, the nuts being mounted on the cross members of the flattened structure.

13. The machine according to claim 9, wherein said lower horizontal drive means comprises:
a fourth brushless gearmotor, equipped with a drive shaft; and
a lever connected with a second chain transmission to said drive shaft and having a left end and a right end, respectively connected with respective joints to the lower left blade holder slide and to the lower right blade holder slide.

14. The machine according to claim 7, in which each momentary locking device for locking a fruit oriented in the recess of its fruit-holding flight comprises an elastically deformable member connected to a compressed air system and hung from the upper head by means of a plurality of rods, slidable in guides, fixed to the upper head by means of a transverse bar.

15. The machine according to claim 14, wherein said elastically deformable member comprises two half-cups side by side and mutually spaced by a slot to allow the passage of the upper blades.

16. The machine according to claim 8, each upper cutting blade of which and/or each lower cutting blade of which is configured like the cutting blade claimed in claim 4.
